(19) United States
(12) Patent Application Publication
(10) Pub. No.: US 2017/0174182 A1
(43) Pub. Date: Jun. 22, 2017

(54) MULTI-AREA MEASURING RAIN SENSOR

(71) Applicants: Hyundai Motor Company, Seoul (KR); Kia Motors Corporation, Seoul (KR)

(72) Inventors: Jong Min Park, Seoul (KR); Nak Kyoung Kong, Seongnam (KR); Keon Soo Jin, Ulsan (KR); Ki Hong Lee, Seoul (KR); Jin Sang Lee, Yongin (KR)

(21) Appl. No.: 15/205,763

(22) Filed: Jul. 8, 2016

(30) Foreign Application Priority Data
Dec. 16, 2015 (KR) 10-2015-0180074

(51) Int. Cl. B60S 1/08; G01N 21/552

(52) U.S. Cl. CPC B60S 1/0833; G01N 21/552; G01N 2201/062; G01N 2201/0636; G01N 2201/0633

(57) ABSTRACT

A multi-area measuring rain sensor is provided with a reflection plate having different reflection angles, to reflect light emitted from a light emitter along different light paths, thereby measuring an amount or quantity of raindrops through sequential time division of light according to differences of the light paths of the reflected light. In particular, the multi-area measuring rain sensor is capable of forming, at a glass, sensing areas equal in number to a maximum number of light receivers, using light beams split from light emitted from each light emitter while having different reflection angles by the reflection plate, which has different reflection angles to reflect light emitted from the light emitter along the different light paths.

### CROSS-REFERENCE TO RELATED APPLICATION

This application claims under 35 U.S.C. §119(a) the benefit of Korean Patent Application No. 10-2015-0180074 filed on Dec. 16, 2015, the entire contents of which are incorporated herein by reference.

### BACKGROUND

(a) Technical Field

The present invention relates to a multi-area measuring rain sensor, more particularly, to a multi-area rain sensor capable of accurately measuring an amount or quantity of raindrops falling onto a windshield window through an increase in sensing area, thereby automatically controlling an operation or speed of windshield wipers.

(b) Description of the Related Art

Conventionally, a rain sensor is a device for automatically controlling a speed or operating time of windshield wipers without requiring separate operation of the driver by sensing intensity and amount of raindrops falling onto a windshield glass.

Such a rain sensor is also referred to as a raindrop sensor. The rain sensor may help reduce accidents or driving inconvenience when the driver turns his or her eyes or is otherwise distracted while driving a vehicle in order to separately adjust an operation or speed of windshield wipers.

That is, when raindrops fall onto a windshield glass, a rain sensor, which is installed at a rear surface of the windshield glass, senses an amount (i.e., a quantity) and a speed of raindrops falling onto the windshield glass, using infrared light, and controls windshield wipers to operate at an increased or reduced speed in accordance with the sensed raindrop amount and speed.

Rain sensors typically have a configuration including one light emitter and one light receiver and, as such, the sensing area thereof is limited, and there is difficulty in accurately measuring an amount and a speed of raindrops. For this reason, an increase in sensing area is required in order to achieve accurate measurement.

FIG. 1 (RELATED ART) shows a conventional rain sensor. The conventional rain sensor has a configuration in which a light emitter and a light receiver are symmetrically arranged, and light emitted from the light emitter is incident upon a windshield glass via a collimator and a reflector.

However, the rain sensor shown in FIG. 1 also has a narrow sensing area because one light emitter and one light receiver are used. In this regard, the rain sensor of FIG. 1 does not have multiple sensing areas.

Korean Unexamined Patent Publication No. 10-2015-0040711 discloses a rain sensor capable of simply estimating an amount of raindrops falling onto a windshield glass, using a plurality of lenses. However, this publication only discloses a configuration in which a single light emitter having a single sensing area is used, and thus may have the same problem as that of the above-mentioned conventional rain sensor.

### SUMMARY

The present invention relates to a rain sensor having multiple sensing areas, using a single light emitter.

The present invention also relates to a rain sensor having a configuration capable of measuring an amount (i.e., a quantity) of raindrops falling onto a windshield glass through a plurality of sensing areas provided through sequential time division of light.

The present invention also relates to a reflection plate having an integrated structure having a plurality of reflection angles to allow light emitted from one light emitter to have a plurality of parallel travel paths.

In one aspect, the present invention provides a multi-area measuring rain sensor of a vehicle including one or more light emitters for emitting light, a reflection plate arranged to correspond to each of the light emitters while being spaced apart from the corresponding light emitter by a predetermined distance, a glass for again reflecting light reflected by the reflection plate, and one or more light receivers for receiving the reflected light again reflected by the glass, wherein the reflection plate splits the light emitted from the corresponding light emitter into a plurality of reflected light beams respectively having different reflection angles while reflecting the light, wherein the number of the reflected light beams split by the reflection plate is equal to a maximum number of the sensing areas.

In a preferred embodiment, when the reflected light beams split by the reflection plate are received by the receivers, the reflected light beams, which reach the receivers, have the same amount of light.

In another preferred embodiment, the amounts of light respectively incident upon the light receivers may be determined by the following expression:

$$Id 10 = Id 20 {( \frac{x 2}{x 1 + x 2} )}^{2}$$

where, “x1” is a horizontal distance from each of the light emitters to a first light receiver, “x2” is a horizontal distance from the first light receiver to a second light receiver, “Id10” is an amount of light initially output from the light emitter to the first light receiver, and “Id20” is an amount of light initially output from the light emitter to the second light receiver.

In still another preferred embodiment, the light emitted from each of the light emitters may be incident upon the light receivers after being reflected one time by each of the reflection plate and the glass.

In yet another preferred embodiment, each of the light emitters may include an infrared light emitting diode (LED).

In still yet another preferred embodiment, the reflection plate may include a parabolic mirror having a plurality of reflection angles.

In still yet another preferred embodiment, the sensing areas may be respectively measured based on the reflected light beams, one or more of which are sequentially incident upon a corresponding one of the light receivers through sequential time division.

In still yet another preferred embodiment, the reflection plate may have reflection angles of approximately 0° and 15°.

In still yet another preferred embodiment, the multi-area measuring rain sensor may further include a collimator arranged at an inner surface of the glass, wherein the collimator allows the light beams reflected by the reflection plate to form collimated light.

In still yet another preferred embodiment, the collimator may include a Fresnel lens.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 (RELATED ART) is a schematic view illustrating a conventional rain sensor having a configuration for incidence of collimated light;

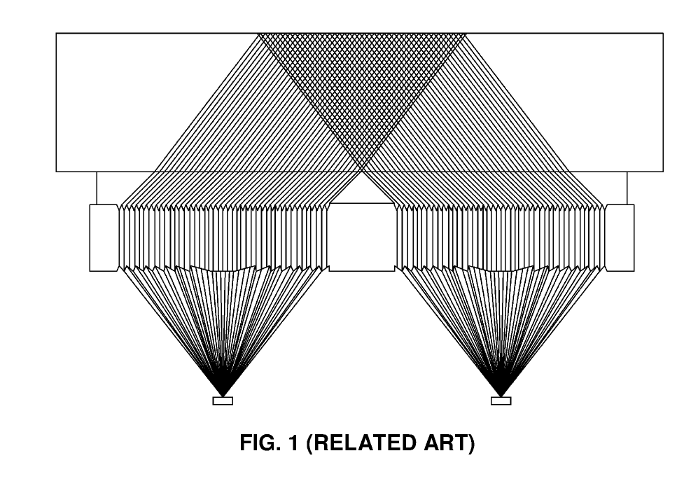

FIG. 2 is a schematic view illustrating a configuration of a multi-area measuring rain sensor according to an embodiment of the present invention;

FIG. 3 is a side view of a multi-area measuring rain sensor according to an embodiment of the present invention;

FIG. 4 is a schematic view illustrating areas formed by reflected light beams reflected at different reflection angles by a multi-area measuring rain sensor according to an embodiment of the present invention;

FIG. 5 is a schematic view illustrating arrangement of light emitters and light receivers in a multi-area measuring rain sensor according to an embodiment of the present invention;

FIG. 6 is a schematic view illustrating travel paths of light beams reflected to two areas in a multi-area measuring rain sensor according to an embodiment of the present invention; and

FIG. 7 is a side view illustrating travel paths of reflected light beams in a multi-area measuring rain sensor according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

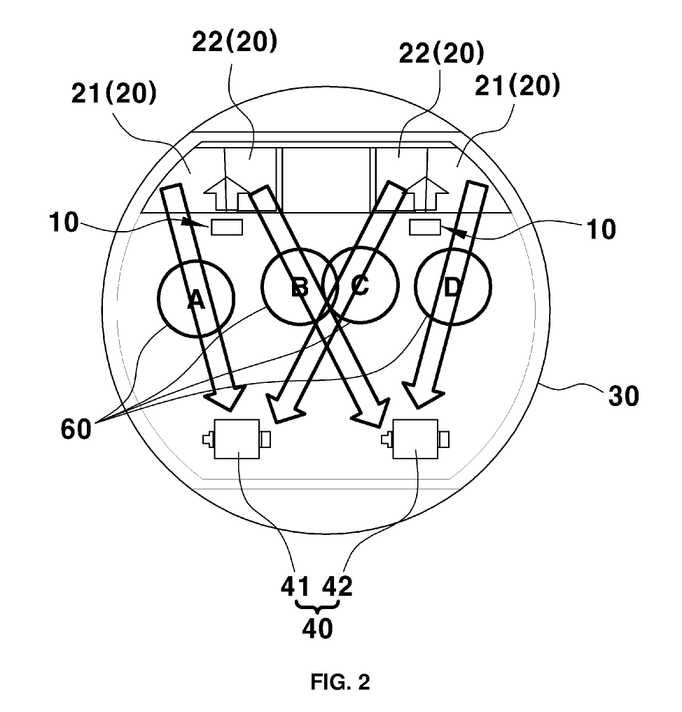

FIG. 2 illustrates a configuration of a multi-area measuring rain sensor according to an embodiment of the present invention.

The multi-area measuring rain sensor includes at least one light emitter 10 to emit light onto a glass 30. In the illustrated embodiment, two light emitters 10 are provided. Of course, the present invention is not limited to the above-described configuration, and may have any configuration including one or more light emitters. Each light emitter 10 may be constituted by an infrared light emitting diode (LED) to emit infrared light. Of course, various light emitters to emit light other than infrared light may be used. The multi-area measuring rain sensor also includes a plurality of light receivers 40 to receive light beams reflected along a plurality of light paths. The received reflected light beams are light beams reflected from a surface of the glass 30 after being emitted from the light emitters 10. Light incident upon the glass 30 may be transmitted through or scattered by water drops on a surface of the glass 30. As a result, the amount of light incident upon each light receiver 40 may vary in accordance with whether or not there are water drops on the surface of the glass 30.

The light receivers 40 utilize variation in difference of optical signals converted from light beams received along multiple optical paths established in a narrow area by at least one light emitter 10. That is, the plurality of light receivers 40 receive light beams reflected along multiple optical paths after being emitted from each light emitter 10 so as to check a state of the surface of the glass 30, using variation in differences of reflected light beams sequentially received. As each light receiver 40, a photodiode to convert optical energy into electrical energy may be used.

In accordance with an embodiment of the present invention, reflection plates 20 may be arranged at positions adjacent to corresponding ones of the light emitters 10 while being spaced apart from the corresponding light emitters 10 by a predetermined distance, respectively. Each reflection plate 20 preferably is adjacent to each light emitter 10 to split reflected light beams to have different reflection angles. When light emitted from each light emitter 10 is reflected by the corresponding reflection plate 20, the reflected light beams may be split into at least two reflected light beams.

Each reflection plate 20 may be made of a reflective material exhibiting higher light reflection than light absorption or light transmission. For example, each reflection plate 20 may be made of a metal such as Al, Ag, Au, or Cu, paint (resin) such as white paint, enamel, or vitreous enamel, paper such as vellum, compressed paper, Kent paper, or albumen paper, or stone such as white tile.

Each reflection plate 20 of the present invention has a configuration having at least one reflection angle. In an embodiment, the reflection plate 20 has two reflection angles. That is, the reflection plate 20 includes a first reflection portion 21 for reflecting light emitted from the corresponding light emitter 10, to generate reflected light having a reflection angle of approximately 0°, and a second reflection portion 22 for reflecting light emitted from the corresponding light emitter 10, to generate reflected light having a reflection angle of approximately 15°. Thus, light emitted from one light emitter 10 is incident upon the glass 30 at two areas via the corresponding reflection plate 20, which is configured to have two reflection angles, as described above. Accordingly, it may be possible to provide two sensing areas at the glass 30, using one light emitter 10. In a preferred embodiment, two light emitters 10 and two reflection plates 20 each having two reflection angles are provided. In this case, the glass 30 may be provided with four sensing areas A, B, C, and D.

As described above, reflection plates 20 each having a plurality of different reflection angles are provided to correspond to respective light emitters 10. Light emitted from each light emitter 10 is split into reflected light beams traveling along a plurality of paths by the corresponding reflection plate 20. In this case, the number of reflected light beams may be equal to a maximum number of light receivers 40.

The plurality of reflected light beams is incident upon a plurality of areas provided at the glass 30 and, as such, a plurality of sensing areas may be provided at the glass 30. In this case, the number of reflected light beams incident upon respective sensing areas after being emitted from each light emitter 10 may be equal to a maximum number of light receivers 40. That is, in an embodiment of the present invention, two reflected light beams are generated in accordance with use of one light emitter 10 and two light receivers 40 and, as such, two sensing areas are provided at the glass 30. In a preferred embodiment of the present invention, the rain sensor has a configuration including two light emitters 10, two light receivers 40, and a reflection plate 20 having two reflection angles and, as such, provides a maximum number of four sensing areas.

Thus, in accordance with the present invention, the reflection plate 20, which corresponds to one light emitter 10, may be configured to have n different reflection angles. That is, n reflected light beams may be generated by the reflection plate 20. In this case, n light receivers 40 may be provided to receive n reflected light beams. In accordance with this configuration, n sensing areas may be provided at the glass 30. In a preferred embodiment, when m light emitters 10 are provided to a multi-area measuring rain sensor including reflection plates 20 each having n reflection angles while corresponding to each light emitter 10, m*n sensing areas may be provided at the glass 30. In this case, at least n light receivers 40 may be provided.

Further, when one reflection plate 20 having n reflection angles is provided to correspond to one light emitter 10, and at least n light receivers 40 are provided, n reflected light beams are incident upon the light receivers 40 corresponding thereto along different light paths, respectively. In this case, travel lengths of reflected light beams may differ from one another. Accordingly, reflected light beams may be sequentially incident upon respective light receivers 40 and, as such, it may be possible to measure sensing areas based on respective reflected light beams. Thus, in accordance with the present invention, it may be possible to sense the sensing areas through sequential time division of light as light beams are sequentially incident upon respective light receivers 40.

That is, in accordance with the present invention, the plurality of light receivers 40 performs sequential light reception via travel paths of reflected light beams. In this case, the amount of raindrops falling onto the glass 30 is determined based on reflected light beams incident upon respective light receivers 40 through the sequential time division of light.

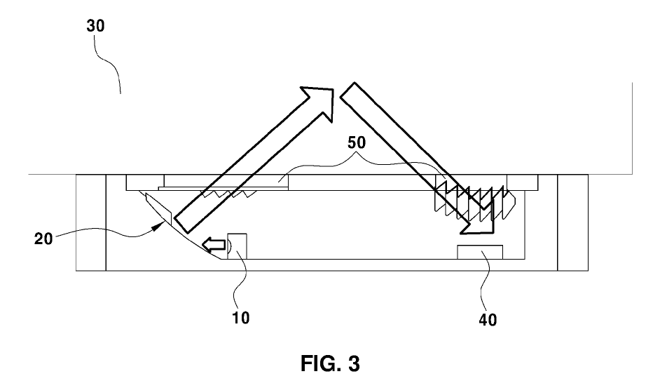

FIG. 3 illustrates a side view of a multi-area measuring rain sensor according to an embodiment of the present invention.

In this case, one light emitter 10 and one light receiver 40 are laterally symmetrically arranged. Light reflected from a reflection plate 20 is then totally reflected by the glass 30. Preferably, the incidence angle of reflected light incident upon the glass 30 is equal to the reflection angle of light reflected from the glass 30. In this case, a collimator 50 is further provided. The collimator 50 is arranged at an inner surface of the glass 30. When reflected light is incident upon the glass 30, the reflected light passes through the collimator 50 prior to incidence upon the glass 30 and, as such, may be collimated. The same configuration as described may also be provided to allow reflected light again reflected to the light receiver 40 to be incident upon the light receiver 40 in the form of collimated light. That is, the collimator 50 has a configuration to cause light reflected by the reflection plate 20 to be maintained in the form of collimated light.

Since the reflection plate 20 has a plurality of reflection angles in this case, light emitted from the light emitter 10 may be split into a plurality of reflected light beams. In this case, the split reflected light beams may be set to have critical angles to allow the reflected light beams to be totally reflected from the glass 30, respectively.

In an embodiment of the present invention, since the split reflected light beams are incident upon the collimator 50 prior to the glass 30, the collimator 50 may take the form of a Fresnel lens and set critical angles allowing the split reflected light beams to be totally reflected from the glass 30. In a preferred embodiment, the collimator 50 taking the form of a Fresnel lens is symmetrically arranged with respect to the glass 30. In this case, reflected light incident upon the glass 30 is refracted through the collimator 50 to have a critical angle causing the reflected light to be totally reflected from the glass 30, and is then incident upon the light receiver 40 after being reflected from the glass 30.

In a more preferred embodiment, the split light beams may be totally reflected from the glass 30 by the collimator 50 taking the form of a Fresnel lens, and the structure and shape of the collimator 50 may be varied in accordance with the number of reflected light beams split by the reflection plate 20 and the distance from the reflection plate 20 to the glass 30.

In addition, the collimator 50 may be configured to allow a plurality of reflected light beams reflected from the glass 30 to be incident upon one light receiver. That is, sensing areas are formed at the glass 30 by a plurality of reflected light beams generated as light emitted from the light emitter 10 is split by the reflection plate, and the collimator 50 has a predetermined curvature allowing the split reflected light again reflected from the glass 30 to be incident upon one light receiver 20.

Light emitted from each light emitter 10 is split into reflected light beams having different reflection angles, and is then totally reflected from the glass 30 by the collimator 50 having the above-described configuration. The reflected light beams are subsequently incident upon at least one light receiver 40 after passing through a portion of the collimator 50 arranged at a position adjacent to the light receiver 40. The light beams, which are incident upon one light receiver 40, have different light paths, respectively, and, as such, the light receiver 40 may measure reflected light beams sequentially incident thereupon through time division of light.

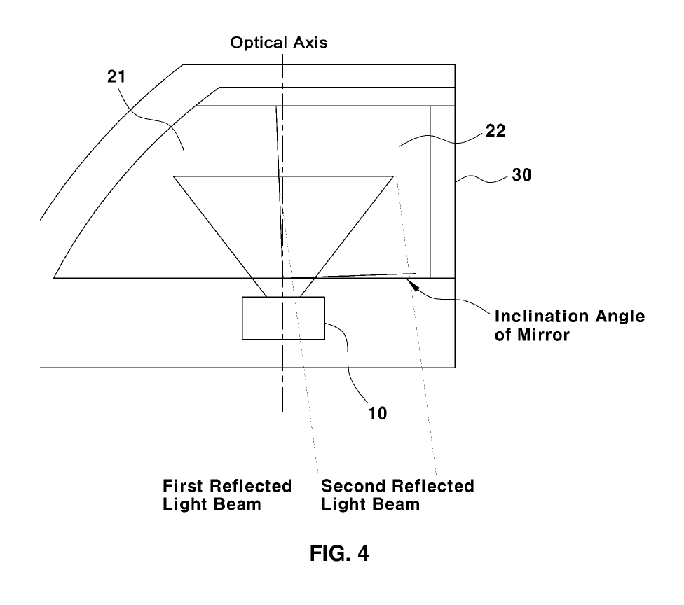

FIG. 4 illustrates a configuration of the multi-area measuring rain sensor according to an embodiment of the present invention in which light is reflected by one reflection plate 20 after being emitted from one light emitter 10.

As illustrated in FIG. 4, light emitted from one light emitter 10 may be infrared light emitted from an infrared LED. The light may be incident upon one reflection plate 20 arranged at a wall surface opposite to a light receiver 40. The reflection plate 20 includes a first reflection portion 21 and a second reflection portion 22 and, as such, light incident upon the reflection plate may be reflected by the reflection plate 20 in the form of a first reflected light beam and a second reflected light beam. In an embodiment of the present invention, the first reflection portion 21 has an inclination angle of approximately 0° with respect to the plane of the reflection plate 20, and the second reflection portion 22 has an inclination angle of approximately 15° with respect to the plane of the reflection plate 20. Accordingly, the first and second reflected light beams have an angle difference of approximately 15° therebetween in a vertical direction.

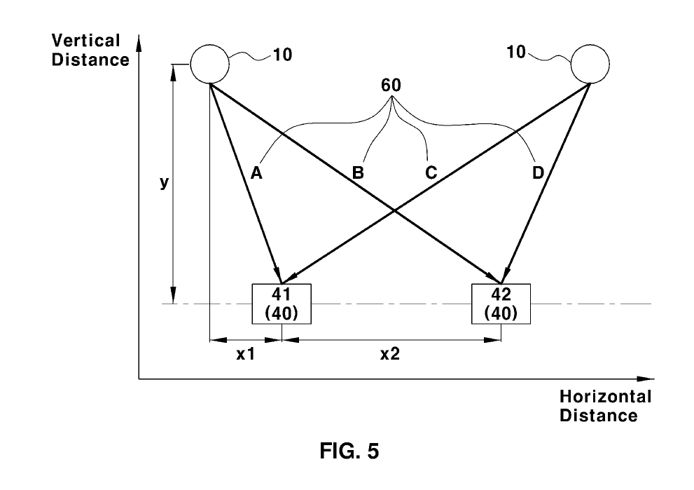

FIG. 5 illustrates distance relations of two light emitters 10 and two light receivers 40 in an embodiment of the present invention.

In accordance with the present invention, the light receivers 40 receive the same amount of light when light emitted from each light emitter 10 is incident upon the light receivers 40. Since the plurality of light receivers 40 receive a plurality of reflected light beams having different travel paths, it may be possible to prevent the light receivers 40, which have the same optical sensitivity, from exhibiting measurement sensitivity differences, so long as the light receivers 40 receive the same amount of light. This is because light emitted from each light emitter 10 is incident upon each light receiver 40 via different travel paths. Accordingly, variation in light power is taken into consideration upon determining an amount of light initially emitted from each light emitter 10.

In the configuration according to the illustrated embodiment of the present invention, in which two light emitters 10 and two light receivers 40 are provided, it may be assumed that “y” is the vertical length between each light emitter 10 and each light receiver 40, “x1” is the horizontal distance between a first light receiver 41, and the light emitter 10, and “x2” is the horizontal distance between the first light receiver 41 and a second light receiver 42. It may also be assumed that “Id10” is an amount of light initially output from each light emitter 10 to the first light receiver 41, and “Id20” is an amount of light initially output from the light emitter 10 to the second light receiver 42.

When there is no irregular reflection or power loss of a plurality of reflected light beams incident upon a plurality of light receivers 40, it may be possible to determine amounts of reflected light received by respective light receivers 40 such that the amounts of reflected light are equal. To this end, it is necessary to calculate travel distances of reflected light beams incident upon respective light receivers 40 after being split from light emitted from each light emitter 10. This calculation may be achieved using the following Expression 1:

$$d 1 = tan θ = {( \frac{x 1}{y} )}^{2} , d 2 = tan {θ}^{′} = {( \frac{x 1 + x 2}{y} )}^{2} \qquad [ Expression 1 ]$$

where, “θ” is an angle of reflected light incident upon the light receiver 40 arranged adjacent to each light emitter 10 (half of a rotation angle of the reflection plate), and “θ′” is an angle of reflected light incident upon the light receiver 40 arranged far from each light emitter 10 (half of a rotation angle of the reflection plate).

In addition, power variation occurring during travel of reflected light may be calculated using the following Expression 2.

$$Id 1 = I 0 {( \frac{1}{D 1} )}^{2} = Id 10 {( \frac{y}{x 1} )}^{2} \\ Id 2 = I 0 {( \frac{1}{D 2} )}^{2} = Id 20 {( \frac{y}{x 1 + x 2} )}^{2} \qquad [ Expression 2 ]$$

When travel paths and power variation of light emitted from each light emitter 10 are taken into consideration, as described above, it may be possible to calculate an initial amount of light emitted from the light emitter such that a plurality of light receivers 40 receive the same amount of light (Id1=Id2), using the following Expression 3:

$$Id 10 = Id 20 {( \frac{x 2}{x 1 + x 2} )}^{2}$$

That is, amounts of reflected light beams having two different reflection angles may be set, and the set amounts of reflected light beams may be incident upon two light receivers 40 having the same sensitivity each. In the above-described configuration in which one light emitter 10 and two light receivers 40 are used, it may be possible to set amounts of reflected light beams incident upon respective light receivers 40 to be equal by setting amounts of light beams output to the light receivers 40 such that the amount of light output to the light receiver 40 arranged adjacent to the light emitter 10, that is, Id10, and the amount of light output to the light receiver 40 arranged far from the light emitter 10, that is, Id20, have a relation of

$$Id 10 = Id 20 {( \frac{x 2}{x 1 + x 2} )}^{2} .$$

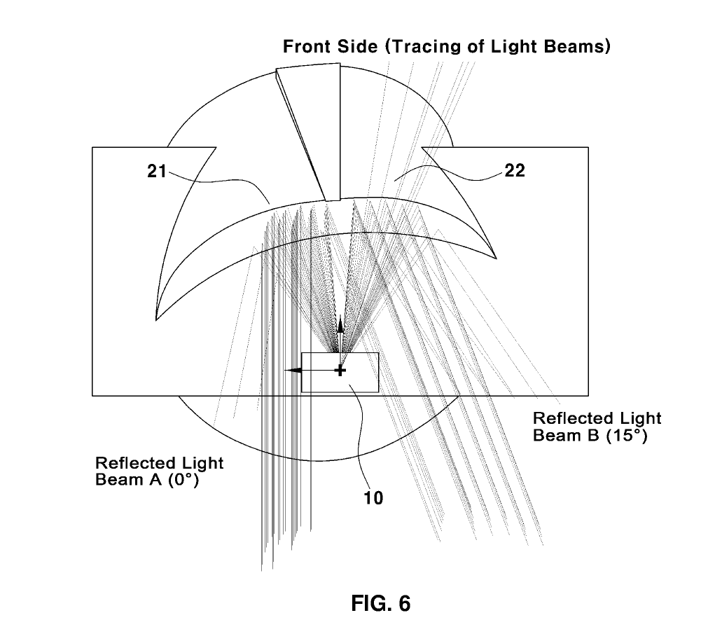

FIG. 6 illustrates travel paths of light in the multi-area measuring rain sensor according to the present invention.

Referring to FIG. 6, a reflection plate 20 including a first reflection portion 21 and a second reflection portion 22 is illustrated. Light emitted from one light emitter 10 is incident upon the glass 30 after being split into reflected light beams A and B by the reflection plate 20 having two reflection angles. The reflection plate 20 having the above-described configuration may be a parabolic reflection mirror having a plurality of reflection angles. When the reflection plate 20 is constituted by a parabolic reflection mirror, the reflection angles thereof are preferably approximately 0° and 15°.

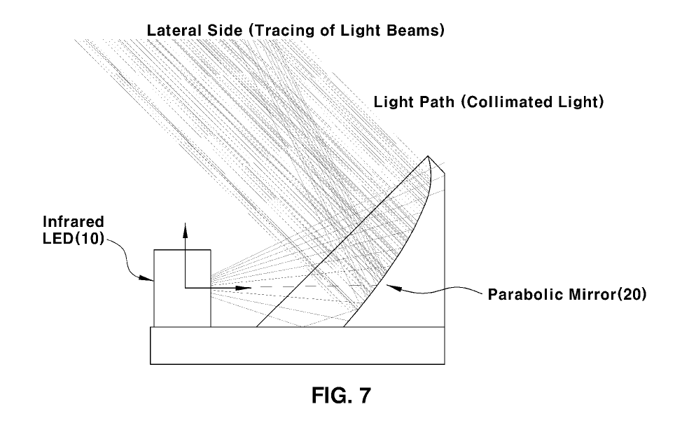

FIG. 7 is a side view illustrating a configuration in which light is reflected by a parabolic mirror having a plurality of reflection angles in accordance with the present invention.

In this case, a single light emitter 10, which is constituted by an infrared LED, as described above, is arranged to face a reflection plate 20. Accordingly, light emitted from the light emitter 10 is incident upon a glass 30 after being reflected by the reflection plate 20. Light reflected by the reflection plate 20 is collimated light and, as such, provides a sensing area having a certain size to the glass 30.

In addition, the rain sensor according to the present invention may include a controller for receiving electrical signals from a light receiver 40, and calculating variation in difference of amounts of received light, based on the received electrical signals. The controller receives an electrical signal corresponding to the intensity of light incident upon the light receiver 40. For example, the controller calculates variation in difference of amounts of light sequentially incident upon the light receiver 40 after being emitted from respective light emitters 10, in the form of a current value or a voltage value. The controller may calculate one or both of momentary absolute variation depending on the above-described light amount variation and accumulated variation depending on the above-described light amount variation based on time. Here, momentary absolute variation may be static variation, and accumulated variation for a predetermined time may be dynamic variation.

The controller may perform a control operation to sequentially generate optical signals corresponding to light beams sequentially incident upon the light receiver 40 after being emitted from the light emitter 10. The controller may provide the calculated light amount difference variation as a signal required to control operation of a wiper system in the vehicle as well as calculate variation of difference of amounts of light emitted from respective light emitters 10.

As apparent from the above description, the present invention may provide the following effects through the above-described configurations and combinations thereof.

In accordance with the present invention, there is provided a reflection plate to generate reflected light beams having a plurality of parallel travel paths without any additional configuration by reflecting light emitted from one light emitter. Accordingly, it may be possible to provide a plurality of sensing areas, using a single light emitter.

In addition, it may be possible to provide a rain sensor having a plurality of sensing areas by use of a single light emitter. Accordingly, it may be possible to sense an amount (i.e., a quantity) of raindrops over a wider area.

Further, it may be possible to more accurately sense an amount of raindrops through the above-described configuration providing a wide sensing area. Accordingly, it may be possible to achieve operation of windshield wipers meeting a driver's desire.

In addition, a reflection plate having a plurality of reflection angles is provided and, as such, more accurate and stable sensing may be achieved through a simple construction.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A multi-area measuring rain sensor of a vehicle, comprising:
one or more light emitters for emitting light;
a reflection plate arranged to correspond to each of the light emitters while being spaced apart from the corresponding light emitter by a predetermined distance;
a glass for again reflecting the light reflected by the reflection plate, thereby forming sensing areas; and
one or more light receivers for receiving the reflected light again reflected by the glass,
wherein the reflection plate splits the light emitted from the corresponding light emitter into a plurality of reflected light beams respectively having different reflection angles while reflecting the light,
wherein the number of the reflected light beams split by the reflection plate is equal to a maximum number of the sensing areas.

2. The multi-area measuring rain sensor of claim 1, wherein when the reflected light beams split by the reflection plate are incident upon the receivers, the reflected light beams, which reach the receivers, have the same amount of light.

3. The multi-area measuring rain sensor of claim 2, wherein the amounts of light respectively incident upon the light receivers are determined by the following expression:
Id10=Id20(x2/x1+x2)²
where, x1 is a horizontal distance from each of the light emitters to a first light receiver, x2 is a horizontal distance from the first light receiver to a second light receiver, Id10 is an amount of light initially output from the light emitter to the first light receiver, and Id20 is an amount of light initially output from the light emitter to the second light receiver.

4. The multi-area measuring rain sensor of claim 1, wherein the light emitted from each of the light emitters is incident upon the light receivers after being reflected one time by each of the reflection plate and the glass.

5. The multi-area measuring rain sensor of claim 1, wherein each of the light emitters comprises an infrared light emitting diode (LED).

6. The multi-area measuring rain sensor of claim 1, wherein the reflection plate comprises a parabolic mirror having a plurality of reflection angles.

7. The multi-area measuring rain sensor of claim 1, wherein the sensing areas are respectively measured based on the reflected light beams, one or more of which are sequentially incident upon a corresponding one of the light receivers through sequential time division.

8. The multi-area measuring rain sensor of claim 1, wherein the reflection plate has reflection angles of approximately 0° and 15°.

9. The multi-area measuring rain sensor of claim 1, wherein the light reflected by the reflection plate forms collimated light.

10. The multi-area measuring rain sensor of claim 1, further comprising:
a collimator arranged at an inner surface of the glass, to cause the light reflected by the reflection plate to be totally reflected from the glass.

11. The multi-area measuring rain sensor of claim 10, wherein the collimator comprises a Fresnel lens.
